(19) United States
(12) Patent Application Publication
(10) Pub. No.: US 2006/0053449 A1
(43) Pub. Date: Mar. 9, 2006

(54) Graded access to profile spaces

(75) Inventor: Srinivas Gutta, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/538,092

(22) PCT Filed: Nov. 25, 2003
(86) PCT No.: PCT/IB03/05510

§ 371 Date: Jun. 8, 2005

Related U.S. Application Data
(60) Provisional application No. 60/432,308, filed on Dec. 10, 2002.

(51) Int. Cl. H04N 5/445

(52) U.S. Cl. 725/46

(57) ABSTRACT

A method for generating a recommendation for video content to a viewer where the viewer has a user profile corresponding to a viewing history of the viewer. The method including: accessing at least one other user profile corresponding to a viewing history of another user (202); combining a portion of the at least one other user profile with the user profile of the viewer to create a combined user profile (208); and determining a recommendation for video content based on the combined user profile (210).

The present invention relates generally to recommendation of shows and other broadcasts, and more particularly, to personal video recorders (PVR's) having television recommenders for generating recommendation scores based on a graded access to the profile spaces of others.

In co-pending U.S. patent application Ser. No. 10/014,202 (attorney docket US010572), entitled Method and Apparatus for Recommending Items of Interest based on Preferences of a Selected Third Party, the contents of which are incorporated herein by reference, methods and apparatus are provided for swapping of entire user profiles with others. User profiles are generated in the PVR based on a viewing history of the viewer that indicates the viewer's viewing preferences.

Normally when people watch TV, they either watch alone, with their spouse, with their kids, with friends, etc. Therefore, it is not uncommon for PVRs to have multiple user profile spaces. These people might not like their remote friends/relatives to have the same level of access to the various profiles space resident in the PVRs. For example, they might like some friends to have access only to our profile space while other friends to have access to the profile space pertaining to TV interests of self+wife, while others to have access to parents+kids interests.

U.S. Pat. No. 5,754,939, pertains to the automatic creation of target profiles for each of a set of objects. The target profile describes the user's interest level in various types of target objects. The U.S. Pat. No. 5,754,939 patent discloses methods which assess the degree of similarity between the target profiles and objects thereby producing a user-customized rank ordered listing of target objects most likely to be of interest to each user. Also to ensure privacy of the profiles, the user can decide how much access he/she could allow the search engine, for it to compare news articles against the target profile. In addition the user can give selective access to the third parties like advertising companies, cable providers in exchange for cash or other considerations. The application domain they are targeting is the retrieval of news articles and discussion groups. The user can also give access to third parties like advertising companies, cable providers. However, the access is not provided for the purpose of creating a new user profile.

Therefore it is an object of the present invention to provide methods and apparatus for generating a recommendation to a viewer for video content that overcomes the disadvantages of the prior art.

Accordingly, a method for generating a recommendation for video content to a viewer is provided, where the viewer has a user profile corresponding to a viewing history of the viewer. The method comprising: accessing at least one other user profile corresponding to a viewing history of another user; combining a portion of the at least one other user profile with the user profile of the viewer to create a combined user profile; and determining a recommendation for video content based on the combined user profile.

Preferably, the accessing comprises the other user providing at least partial access to the at least one other user profile through a communication channel.

Where the viewer has limited access to the at least one other user profile, the combining preferably comprises the other user designating the portion of the at least one other user profile which can be combined with the user profile of the viewer.

Where the viewer has access to more than the portion of the at least one other user profile, the combining preferably comprises the viewer designating the portion of the at least one other user profile which is to be combined with the user profile of the viewer.

The combining alternatively comprises automatically combining the user profile of the viewer with the portion of the at least one other user profile according to a predetermined criteria. The predetermined criteria preferably comprises adding sub-portions of the at least one other user profile to the user profile of the viewer which are not present in the user profile of the viewer.

The method preferably further comprises assigning weights to at least a portion of the portion of the at least one other user profile before the combining to create a weighted combined user profile, wherein the determining comprises determining the recommendation for the video content based on the weighted combined user profile.

The accessing alternatively comprises: requesting the at least one other user profile according to a predetermined characteristic; receiving at least one response to the request; and selecting the at least one response based on the predetermined characteristic. The receiving preferably further comprises soliciting a corresponding price for the use of the at least one other user profile, wherein the selecting comprises selecting the at least one response based on the predetermined characteristic and the corresponding price.

Also provided is an apparatus for generating a recommendation for video content to a viewer where the viewer has a user profile corresponding to a viewing history of the viewer. The apparatus comprising: communication means for accessing at least one other user profile corresponding to a viewing history of another user; a processor for combining a portion of the at least one other user profile with the user profile of the viewer to create a combined user profile; and a recommender for determining a recommendation for video content based on the combined user profile.

Wherein the viewer has access to more than the portion of the at least one other user profile and the apparatus further comprises a user interface in which the viewer designates the portion of the at least one other user profile which is to be combined with the user profile of the viewer.

The apparatus alternatively further comprises means for automatically combining the user profile of the viewer with the portion of the at least one other user profile according to a predetermined criteria. Preferably, the means for automatically combining the user profile of the viewer with the portion of the at least one other user profile comprises the processor. The predetermined criteria preferably comprises adding sub-portions of the at least one other user profile to the user profile of the viewer which are not present in the user profile of the viewer.

The apparatus preferably further comprises a user interface for assigning weights to at least a portion of the portion of the at least one other user profile to create a weighted combined user profile, wherein the recommender determines the recommendation for the video content based on the weighted combined user profile.

The communication means alternatively comprises: means for transmitting a request for the at least one other user profile according to a predetermined characteristic; means for receiving at least one response to the request; and a user interface for selecting the at least one response based on the predetermined characteristic. Preferably, a corresponding price for the use of the at least one other user profile is also received with the at least one response, wherein the user interface comprises means for selecting the at least one response based on the predetermined characteristic and the corresponding price.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

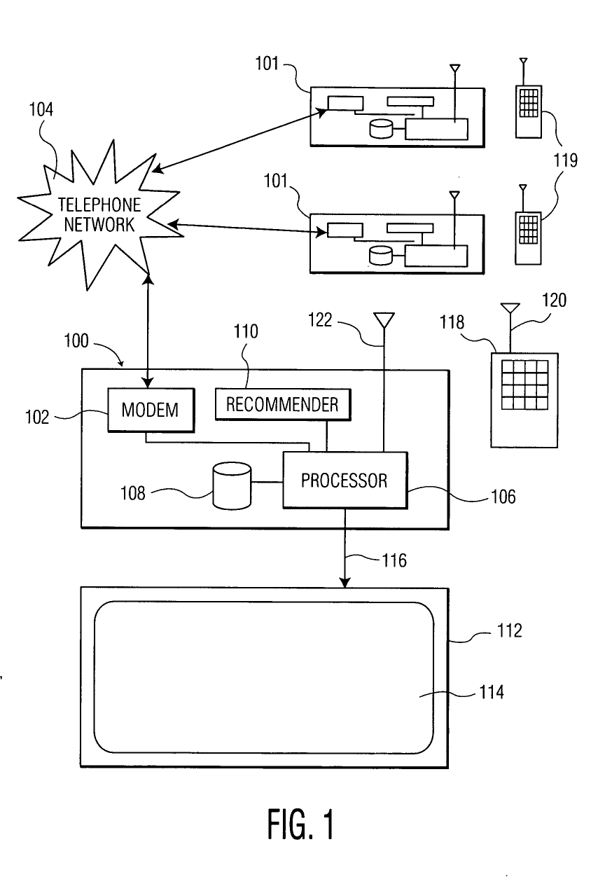

FIG. 1 illustrates a schematic of a preferred implementation of a system for practicing methods of the present invention.

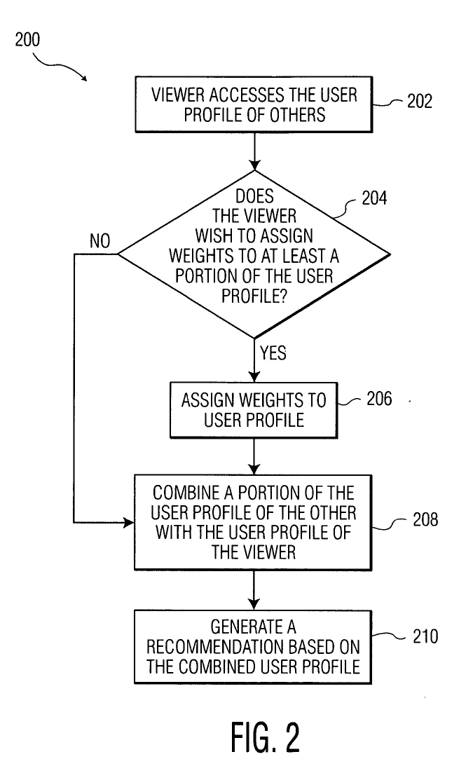

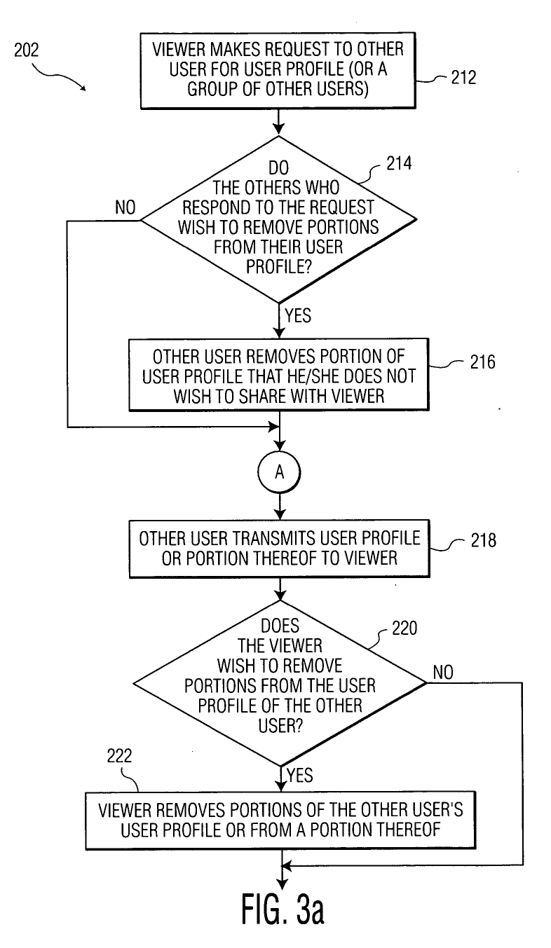

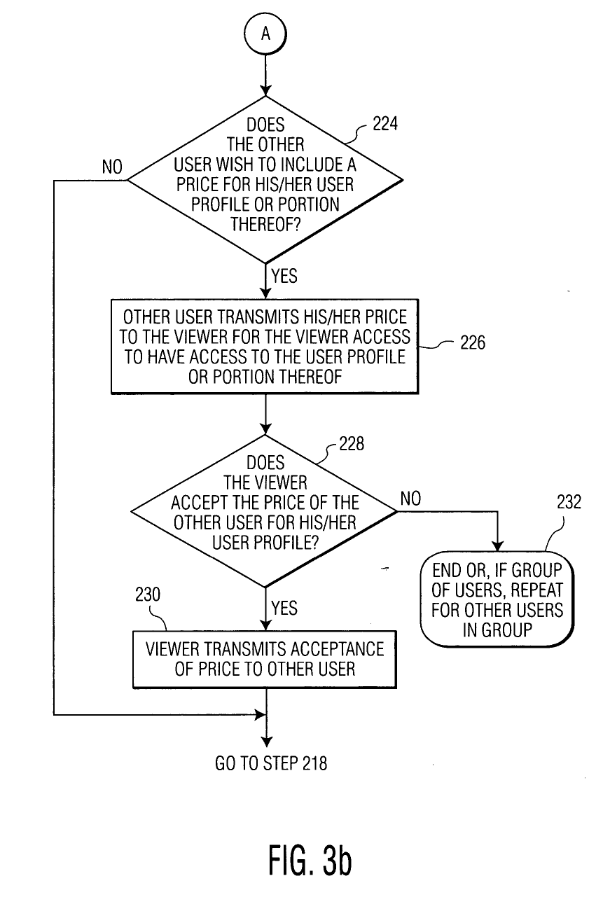

FIGS. 2, 3a, and 3b illustrate flowcharts of a preferred implementation of methods of the present invention.

Although this invention is applicable to numerous and various types of video content, it has been found particularly useful in the environment of television shows. Therefore, without limiting the applicability of the invention to television shows, the invention will be described in such environment.

Referring now to FIG. 1, there is shown a preferred implementation of an apparatus for generating a recommendation for video content to a viewer, the apparatus being generally referred to by reference numeral 100. The apparatus is preferably a personal video recorder (PVR), as are known in the art, such as Replay TV® and TiVo®. The viewer generally has a user profile corresponding to a viewing history of the viewer and indicating the viewing preferences of the viewer. For purposes of this disclosure, “viewer” shall mean that person for whom the video content is being recommended and “users” shall mean those persons corresponding to the plurality of users in remote locations from the viewer. The users in the remote locations each preferably have a similarly equipped apparatus to that of apparatus 100, the apparatus of the users being referred to by reference numeral 101, such apparatus 101 are assumed to include similar features to that of apparatus 100. However, those skilled in the art will appreciate that apparatus 101 can be configured differently from apparatus 100 and still cooperate to perform the methods of the present invention.

The apparatus 100 generally having a communication means, such as a modem 102 operating over a telephone network 104, for accessing at least one of the other user apparatus 101 and to receive at least a portion of at least one user profile stored within the apparatus 101. The apparatus 101 corresponding to the other users also preferably communicate over the same telephone network and as such, can transmit and receive information to and from the viewer. The apparatus 100 further has a processor 106. As will be discussed below, a function of the processor, in addition to carrying out the typical functions of the apparatus 100, is to combine a portion of at least one other user profile with the user profile of the viewer to create a combined user profile. The processor has a storage device 108 operatively connected thereto to store user profiles of the viewer, as well as video content, and instructions for carrying out the methods of the present invention and the typical functions of the apparatus 100. Although shown as a single storage device 108, more than one storage device can be provided for storing any one or more of the above. The apparatus further has a recommender 110 (alternatively known in the art as a recommender or recommendation engine) for determining a recommendation for video content based on a user profile. As will be discussed above, the recommender 110 will determine a recommendation based on a combined user profile, which contains portions of both the viewer's, and at least one other's user profile.

Apparatus 100 further has a monitor 112 operatively connected thereto for displaying video content supplied by the apparatus 100 on a display 114 via signal line 116. The monitor 112 can also display a user interface generated by the apparatus 100 for inputting instructions to the apparatus 100. Specifically, as will be discussed below, the viewer can view a user profile and input which portions of the user profile are to be used in the combined user profile and to assign weights to those portions, if he/she so desires. The viewer can also use the user interface to transmit requests to another user or a group of other users for their user profile or portions thereof, and also to transmit a response to the other users, if necessary. Construction of such a user interface is well within the knowledge of those of ordinary skill in the art, and as such, a detailed description thereof is omitted for the sake of brevity. The apparatus 100 further has a means for engaging with the user interface, such as a remote control 118. The remote control is preferably wireless, as are known in the art, and having a transmitter 120 in wireless communication with a receiver 122 operatively connected to the processor 106. The apparatus 101 corresponding to the other users are preferably similarly equipped with a remote control 119 and a user interface for responding to requests from the viewer.

A preferred implementation of the methods for generating a recommendation for video content to a viewer will now be described with reference to FIGS. 2, 3a, and 3b. The method is generally referred to by reference numeral 200. Referring first to FIG. 2, an overview of the methods of the present invention will be described. In general, the viewer has a user profile corresponding to his/her viewing history. The method generally comprises accessing at least one other user profile corresponding to a viewing history of another user at step 202; combining a portion of the at least one other user profile with the user profile of the viewer to create a combined user profile at step 208, and determining a recommendation for video content based on the combined user profile at step 210. An advantage is that it is often the case that the viewer might like what his/her friends or relatives are watching and would like to watch the same. In such situations, if the viewer's friend allows his/her PVR to provide access to our PVR, then the new information could be combined with the viewer's user profile to generate a new set of recommendations.

Preferably, the method 200 also includes the option of the viewer assigning weights to all or some portions of the user profile which is being combined with the viewer's user profile, to create a weighted combined user profile. In this situation, the recommender 110 determines a recommendation for the video content based on the weighted combined user profile.

Referring now to FIG. 3a, a preferred implementation of step 202 of FIG. 2 will be described. Generally, the viewer accesses the other user or group of other users by making a request at step 212 for at least partial access to the user profile of the other user or group of other users. Preferably, the viewer makes the request via a user interface as discussed above and transmits the request through a communication channel, such as that provided by the modem 102. The viewer preferably has a network of friends/relatives etc. to which he/she makes the request. The other users receive the request from the viewer using the apparatus 101 similarly equipped with a modem and they view and respond to the request using a user interface under the control of the apparatus 101 and displayed on a monitor connected thereto. If one or more of the other users wish to respond to the viewer's request, they input such instructions to the apparatus 101 through the user interface. Preferably, the user has the choice of either transmitting their entire user profile to the viewer or portions thereof. Therefore, at step 214, other users who wish to respond to the viewer's request, first determine how much of their user profile they want to share with the viewer. If the other user wishes to share his/her entire user profile with the viewer, shown schematically as step 214—NO, the method proceeds to step 218 where the other user transmits, via the modems and telephone network, or other communication means, his/her user profile. If the other user wishes to remove portions of his/her user profile, shown schematically as step 214—YES, the other user first removes selected portions of his/her user profile at step 216 through a suitable user interface under the control of the apparatus 101 and transmits only the remaining portions to the viewer at step 218. Alternatively, the other user may set an amount of access for certain friends/relatives, etc. in a group of users. The other user, through an appropriate user interface, would be asked to set access parameters to his/her various friends/acquaintances. As an example, 20% access could be provided to Friend 1, 40% corresponding to self+wife's profile space to Friend 2, etc. Therefore, when a request is received from one of these people, the apparatus 101 can automatically determine how much access to give the person to the user's user profile.

When the viewer receives the user profile of the other user, preferably he/she can also remove selected portions that he/she does not want to be combined with his/her own user profile. At step 220, the viewer decides if he/she wishes to remove any portions of the user profile transmitted by the other user. If the viewer does not wish to remove any portions from the other user's user profile, shown schematically as step 220—NO, the method proceeds to step 204, where the viewer can merely assign weights to selected portions of the other user's user profile instead of deleting the portions. Alternatively, the viewer can neither remove selected portions nor assign weights to selected portions, and can combine as much of the other user's user profile with the user profile of the viewer that the other user was willing to share with the viewer. If the viewer does wish to remove portions of the other user's user profile (or portion thereof), shown schematically as step 220—YES, the method proceeds to step 222 where the viewer selects portions of the other user's user profile to be removed, via an appropriate user interface under the control of the apparatus 100 and displayed to the viewer on the display 112 of the monitor 112. After which, the method proceeds to step 204 as discussed above.

Alternatively, the viewer can request an automatic combination of portions of the user's user profile with his/her user profile through an appropriate user interface or by setting a switch (not shown) or pressing of a corresponding button (not shown). The automatic combining of the user profile of the viewer with the portion of the at least one other user profile is preferably according to a predetermined criteria which can also be selected by the viewer through an appropriate user interface. For example, the predetermined criteria may comprises adding sub-portions of the at least one other user profile to the user profile of the viewer which are not present in the user profile of the viewer. Thus, if the user profile of the other user has a portion that is not present in the user profile of the viewer, that portion will be automatically added to the user profile of the viewer and the combined user profile resulting therefrom will be used to make the recommendation to the viewer.

The viewer may make a broad request to the other user or group of users for their user profile or a portion thereof. However, it is preferable for the viewer to request the user profile according to a predetermined characteristic, such as if the user prefers a certain genre of television show, or a particular actor or actress. When the viewer receives responses to such a request, he or she would then select the response based on the predetermined characteristic, preferably, by which of the responses best meet the predetermined characteristic. The selection is preferably done through a suitable user interface under the control of the apparatus 100 and displayed on the display 114 of the monitor 112.

Referring now to FIG. 3b, a further alternative, referred to by reference numeral A in FIG. 3a, will now be described. Although the other user's and viewer may belong to a group which freely exchange their user profiles among themselves, the methods of the present invention are also applicable to groups of users who wish to be compensated for the use of their user profile. In such a situation, the other user decides whether he/she wishes to solicit a price for the use of their user profile at step 224. For purposes of this disclosure, “price” can mean a monetary compensation, a return favor, or any thing in which the other user realizes compensation, monetary or otherwise. If the other user does not wish to solicit a price for his/her user profile (or portion thereof), shown schematically by step 224—NO, the method proceeds to step 218 where the viewer transmits as much of his/her user profile that he wants the viewer to have. If the other user wishes to solicit a price for his/her user profile (or portion thereof), shown schematically by step 224—YES, the method proceeds to step 226 where the other user transmits his/her price to the viewer. Such information is input into the apparatus 101 using an appropriate user interface. At step 228, the viewer can then either accept or reject the other user's price, shown schematically by steps 228—YES and 228—NO, respectively. If the viewer does not want to pay the price of the other user for his/her user profile, the method proceeds to step 232 where the method ends or, if multiple other users transmitted a response, repeats for the other users. If the viewer agrees to pay the price of the other user for his/her user profile, the method proceeds to step 230 where the viewer transmits the acceptance to the other user. The method then proceeds to step 230 where the other user transmits his/her user profile (or portion thereof) to the viewer. Thus, the methods of the present invention can be further extended by allowing for bidding of user profiles from the other users similar to the scheme used by Ebay or as described in co-pending U.S. application Ser. No. 09/935,886 entitled, Wireless Method for Bidding for the Products of a Provider of such Products, the contents of which are incorporated by reference.

Those skilled in the art will appreciate that the methods of the present invention gives both the other users and viewer versatility in choosing how much of their user profile they wish to share and how much of the shared profile they wish to incorporate into their user profile. Thus, the other user decides how much access he/she would like to give for each profile space via an appropriate user interface. For example, if the other user gives only 50% access to one of the profile spaces then only half of the profile or certain prongs of the profile can be provided to the viewer's recommender 110. Generating a combined user profile can be done as is disclosed in co-pending U.S. application Ser. No. 10/014,202 entitled, Method and Apparatus for Recommending Items of Interest Based on a Preference of a Selected Third Party, the contents of which are incorporated herein by reference. The viewer's recommender 110 would then incorporate the 50% of the profile with his/her own profile and use it to generate recommendations as discussed above and in U.S. application Ser. No. 10/014,202. The viewer's recommender 110 could use all of the profile for which he/she has access or use only part of that profile for which he/she has access to.

Although discussed above with regard to combining only the user profiles of another user and the viewer, any number of user profiles can be combined with that of the viewer's user profile. For instance, the viewer's recommender 110, could use 20% of the user profile space pertaining to the other user, 40% corresponding to the viewer+wife's profile space, and the remaining 40% could correspond to the viewer's own user profile.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for generating a recommendation for video content to a viewer, the viewer having a user profile corresponding to a viewing history of the viewer, the method comprising:
accessing at least one other user profile corresponding to a viewing history of another user;
combining a portion of the at least one other user profile with the user profile of the viewer to create a combined user profile; and
determining a recommendation for video content based on the combined user profile.

2. The method of claim 1, wherein the accessing comprises the other user providing at least partial access to the at least one other user profile through a communication channel (104).

3. The method of claim 2, wherein the viewer has limited access to the at least one other user profile and the combining, comprises the other user designating the portion of the at least one other user profile which can be combined with the user profile of the viewer.

4. The method of claim 2, wherein the viewer has access to more than the portion of the at least one other user profile and the combining comprises the viewer designating the portion of the at least one other user profile which is to be combined with the user profile of the viewer.

5. The method of claim 2, wherein the combining comprises automatically combining the user profile of the viewer with the portion of the at least one other user profile according to a predetermined criteria.

6. The method of claim 1, wherein the predetermined criteria comprises adding sub-portions of the at least one other user profile to the user profile of the viewer which are not present in the user profile of the viewer.

7. The method of claim 1, further comprising assigning weights to at least a portion of the portion of the at least one other user profile before the combining to create a weighted combined user profile, wherein the determining comprises determining the recommendation for the video content based on the weighted combined user profile.

8. The method of claim 1, wherein the accessing comprises: requesting the at least one other user profile according to a predetermined characteristic; receiving at least one response to the request; and selecting the at least one response based on the predetermined characteristic.

9. The method of claim 8, wherein the receiving further comprises soliciting a corresponding price for the use of the at least one other user profile, wherein the selecting comprises selecting the at least one response based on the predetermined characteristic and the corresponding price.

10. An apparatus (100) for generating a recommendation for video content to a viewer, the viewer having a user profile corresponding to a viewing history of the viewer, the apparatus comprising:
communication means (102, 104, 114) for accessing at least one other user profile corresponding to a viewing history of another user;
a processor (106) for combining a portion of the at least one other user profile with the user profile of the viewer to create a combined user profile; and
a recommender (110) for determining a recommendation for video content based on the combined user profile.

11. The apparatus of claim 10, wherein the viewer has access to more than the portion of the at least one other user profile and the apparatus further comprises a user interface in which the viewer designates the portion of the at least one other user profile which is to be combined with the user profile of the viewer.

12. The apparatus of claim 10, further comprising means for automatically combining the user profile of the viewer with the portion of the at least one other user profile according to a predetermined criteria.

13. The apparatus of claim 12, wherein the means for automatically combining the user profile of the viewer with the portion of the at least one other user profile comprises the processor (106).

14. The apparatus of claim 12, wherein the predetermined criteria comprises adding sub-portions of the at least one other user profile to the user profile of the viewer which are not present in the user profile of the viewer.

15. The apparatus of claim 10, further comprising a user interface for assigning weights to at least a portion of the portion of the at least one other user profile to create a weighted combined user profile, wherein the recommender (110) determines the recommendation for the video content based on the weighted combined user profile.

16. The apparatus of claim 10, wherein the communication means (102, 104, 114) comprises:
means (102) for transmitting a request for the at least one other user profile according to a predetermined characteristic;
means (102) for receiving at least one response to the request; and
a user interface (114) for selecting the at least one response based on the predetermined characteristic.

17. The apparatus of claim 16, wherein a corresponding price for the use of the at least one other user profile is also received with the at least one response, wherein the user interface (114) comprises means (118) for selecting the at least one response based on the predetermined characteristic and the corresponding price.

18. A program storage device readable by machine, tangibly embodying a program of instructions executable by the machine to perform method steps for generating a recommendation for video content to a viewer, the viewer having a user profile corresponding to a viewing history of the viewer, the method comprising:
accessing at least one other user profile corresponding to a viewing history of another user;
combining a portion of the at least one other user profile with the user profile of the viewer to create a combined user profile; and
determining a recommendation for video content based on the combined user profile.

19. A computer program product embodied in a computer-readable medium for generating a recommendation for video content to a viewer, the viewer having a user profile corresponding to a viewing history of the viewer, the computer program product comprising:
computer readable program code means for accessing at least one other user profile corresponding to a viewing history of another user;
computer readable program code means for combining a portion of the at least one other user profile with the user profile of the viewer to create a combined user profile; and
computer readable program code means for determining a recommendation for video content based on the combined user profile.
